(19) United States
(12) Patent Application Publication
(10) Pub. No.: US 2026/0058183 A1
(43) Pub. Date: Feb. 26, 2026

(54) FUEL CELL

(71) Applicant: TOYOTA BOSHOKU KABUSHIKI KAISHA, Aichi-ken (JP)

(72) Inventor: Haruyuki AONO, Aichi-ken (JP)

(73) Assignee: TOYOTA BOSHOKU KABUSHIKI KAISHA, Aichi-ken (JP)

(21) Appl. No.: 19/301,028

(22) Filed: Aug. 15, 2025

(30) Foreign Application Priority Data
Aug. 20, 2024 (JP) 2024-139025

(51) Int. Cl. H01M 8/248; H01M 8/2404

(52) U.S. Cl. CPC H01M 8/248; H01M 8/2404

(57) ABSTRACT

A fuel cell includes a fuel cell stack including stacked plate-shaped single cells. The fuel cell includes two end plates that sandwich the fuel cell stack from opposite sides of the fuel cell stack in a stacking direction of the single cells. The fuel cell includes fasteners each rotating about a respective first axis and fastening the two end plates to each other. The respective first axis extends in the stacking direction. The fuel cell includes one rotor configured to rotate about a second axis extending in the stacking direction and provided on an outer surface of one of the two end plates in the stacking direction. The one rotor is configured such that a rotational force generated when the one rotor is rotated is simultaneously transmitted to the fasteners as a rotational force acting in a direction of tightening the fasteners.

### CROSS-REFERENCE TO RELATED APPLICATIONS

This application is based upon and claims the benefit of priority from Japanese Patent Application No. 2024-139025, filed on Aug. 20, 2024, the entire contents of which are incorporated herein by reference.

### BACKGROUND

### 1. Field

The present disclosure relates to a fuel cell.

### 2. Description of Related Art

JP2013-20886A discloses a typical example of a fuel cell. Such a fuel cell includes a fuel cell stack including stacked single cells and two end plates. The two end plates sandwich the fuel cell stack from the opposite sides of the fuel cell stack in the stacking direction of the single cells. The two end plates are fastened using bolts to apply a compressive force to the fuel cell stack.

In the above-described fuel cell, since the bolts are sequentially tightened, the compressive force applied to the fuel cell stack is biased. Accordingly, the surface pressure is not uniformly applied to each single cell of the fuel cell stack. This results in variations in the quality of the fuel cell.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A fuel cell according to an aspect of the present disclosure includes a fuel cell stack including stacked plate-shaped single cells. Each single cell includes a power generating unit and two separators that sandwich the power generating unit. The fuel cell includes two end plates that sandwich the fuel cell stack from opposite sides of the fuel cell stack in a stacking direction of the single cells. The fuel cell includes fasteners each rotating about a respective first axis and fastening the two end plates to each other. The respective first axis extends in the stacking direction. The fuel cell includes one rotor configured to rotate about a second axis extending in the stacking direction and provided on an outer surface of one of the two end plates in the stacking direction. The one rotor is configured such that a rotational force generated when the one rotor is rotated is simultaneously transmitted to the fasteners as a rotational force acting in a direction of tightening the fasteners.

Other features and aspects will be apparent from the following detailed description, the drawings, and the claims.

### BRIEF DESCRIPTION OF THE DRAWINGS

FIG. 1 is a schematic cross-sectional view of a fuel cell according to an embodiment.

FIG. 2 is a plan view of the fuel cell shown in FIG. 1.

FIG. 3 is an exploded perspective view of the single cell.

FIG. 4 is a schematic cross-sectional view of a fuel cell according to a modification.

FIG. 5 is a plan view of the fuel cell shown in FIG. 4.

FIG. 6 is a plan view of a fuel cell according to another modification.

FIG. 7 is a plan view of a fuel cell according to still another modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment will now be described with reference to the drawings.

### Fuel Cell 11

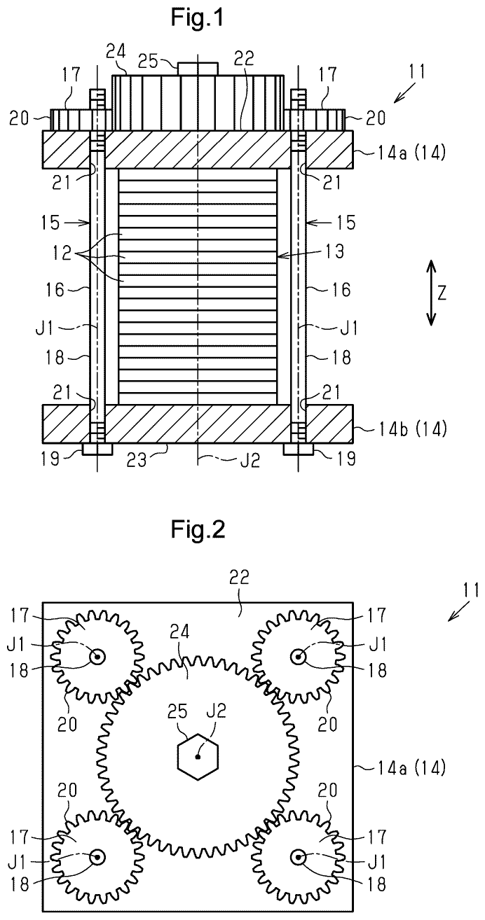

As shown in FIG. 1, a fuel cell 11 includes a fuel cell stack 13 and two end plates 14. The fuel cell stack 13 includes rectangular plate-shaped single cells 12, each generating power. The single cells 12 are stacked in their thickness direction. The two end plates 14 sandwich the fuel cell stack 13 from the opposite sides of the fuel cell stack 13 in a stacking direction Z of the single cells 12.

The two end plates 14 have, for example, a square shape and is made of metal. One of the two end plates 14 is referred to as a first end plate 14a, and the other is referred to as a second end plate 14b. The two end plates 14 are fastened to each other using multiple (four in this example) metal fasteners 15, each rotating about a respective first axis J1 extending in the stacking direction Z, thereby pressing the fuel cell stack 13 so as to compress the fuel cell stack 13 in the stacking direction Z. That is, the fuel cell 11 includes multiple fasteners 15, each rotating about the respective first axis J1, which extends in the stacking direction Z, and fastening the two end plates 14 to each other.

A terminal plate (not shown), which collects current, and an insulating plate (not shown), which performs insulation, are arranged between the fuel cell stack 13 and each of the two end plates 14.

As shown in FIGS. 1 and 2, each fastener 15 includes a bolt 16 having an axis along the first axis J1 and an annular nut 17 having an axis along the first axis J1. The bolt 16 has a shaft 18 and a hexagonal head 19 that is provided at one end of the shaft 18. An annular gear portion 20 is integrally formed on an outer portion of the nut 17. A circular insertion hole 21 extends through a portion proximate to each of the four corners of the two end plates 14. The centers of the four insertion holes 21 in each end plate 14 are located on the same circumference.

The shaft 18 of each bolt 16 is inserted into the corresponding insertion hole 21 of the two end plates 14 so as to connect the two end plates 14 to each other. That is, the shaft 18 of each bolt 16 is inserted into the corresponding insertion hole 21 of the first end plate 14a and the corresponding insertion hole 21 of the second end plate 14b, which is opposite to the insertion hole 21 of the first end plate 14a in the stacking direction Z.

In this case, the tip of the shaft 18 of each bolt 16 protrudes outward in the stacking direction Z from a first outer surface 22, which is an outer surface of the first end plate 14a in the stacking direction Z. Further, the head 19 of the bolt 16 is fixed through, for example, welding while being in contact with a second outer surface 23, which is an outer surface of the second end plate 14b in the stacking direction Z. Thus, the bolt 16 is prevented from rotating about the insertion hole 21.

The nuts 17 are respectively fastened to the tips of the shafts 18 of the four bolts 16, which protrude from the first outer surface 22 of the first end plate 14a. The nuts 17 are rotated in a direction in which they are tightened, thereby fastening the two end plates 14 with four nuts 17 and four bolts 16.

At a central portion of the first outer surface 22 of the first end plate 14a, one gear 24 is provided as an example of one single rotor configured to be rotate in both forward and reverse directions about a second axis J2 extending in the stacking direction Z. That is, the fuel cell 11 includes one gear 24 as an example of one rotor provided on the first outer surface 22 of the first end plate 14a. The second axis J2 passes through the centers of the two end plates 14 and extends parallel to the first axes J1. The gear 24 has a larger outer diameter and a larger thickness than the nuts 17.

One gear 24 is meshed with the gear portions 20 of the four nuts 17. Thus, when rotated, one gear 24 simultaneously transmits a rotational force to the gear portions 20 of the four nuts 17 in a state in which the gear 24 is in direct contact with the gear portions 20. That is, one gear 24 is configured such that a rotational force generated when the gear 24 is rotated is simultaneously transmitted to the four nuts 17 as a rotational force acting in a direction of tightening the nuts 17. The center of the gear 24 has, for example, a hexagonal projection 25 that allows engagement with a general-purpose tool (e.g., a socket wrench) when the gear 24 is rotated.

### Single Cell 12

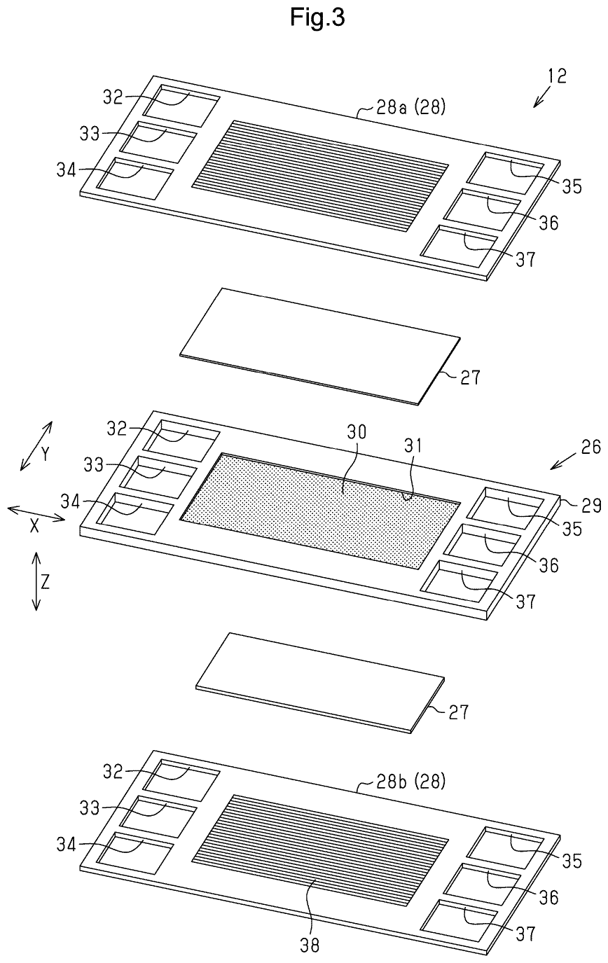

As shown in FIGS. 1 and 3, the single cells 12 each have a rectangular plate shape and are stacked to form the fuel cell stack 13. The single cell 12 includes a power generating unit 26 having the form of a rectangular plate, two gas diffusion layers 27 having the form of a rectangular sheet and sandwiching the power generating unit 26, and two separators 28 having the form of a rectangular plate. That is, the single cell 12 is structured such that the two gas diffusion layers 27, the power generating unit 26, and the two separators 28 are stacked.

The longitudinal direction, the lateral direction, and the thickness direction in the single cell 12 are hereinafter referred to as a longitudinal direction X, a lateral direction Y, and the stacking direction Z, respectively. The longitudinal direction X, the lateral direction Y, and the stacking direction Z are orthogonal to each other. The thickness direction of the single cell 12 is the same direction as the stacking direction Z.

As shown in FIG. 3, the power generating unit 26 includes a rectangular plate-shaped resin frame 29, and a rectangular sheet-shaped power generating unit 30 supported by the frame 29. The power generating unit 30 includes, for example, a membrane electrode assembly (MEA). The frame 29 has a rectangular opening 31 at its central portion.

The frame 29 supports the power generating unit 30, with the power generating unit 30 accommodated in the opening 31. The power generating unit 30 is held between the two gas diffusion layers 27 in the stacking direction Z. The two separators 28 sandwich the power generating unit 26 in the stacking direction Z from the outside of the two gas diffusion layers 27. One of the two separators 28, on the cathode side, is referred to as a first separator 28a, while the other, on the anode side, is referred to as a second separator 28b.

### Passage Structure in Single Cell 12

As shown in FIGS. 1 and 3, the opposite ends of the single cell 12 that sandwich the power generating unit 30 in the longitudinal direction X (i.e., the opposite ends of the frame 29 and the two separators 28 that sandwich the power generating unit 30 in the longitudinal direction X) each have three rectangular through-holes arranged in the lateral direction Y.

The three through-holes at one end of the single cell 12 in the longitudinal direction X are referred to as a fuel gas supply hole 32, a cooling medium discharge hole 33, and an oxidant gas discharge hole 34. The three through-holes at the other end of the single cell 12 in the longitudinal direction X are referred to as an oxidant gas supply hole 35, a cooling medium supply hole 36, and a fuel gas discharge hole 37.

The fuel gas supply hole 32 is included in an inlet-side fuel gas manifold, to which fuel gas is supplied, in the fuel cell stack 13. The fuel gas discharge hole 37 is included in an outlet-side fuel gas manifold, from which fuel gas is discharged, in the fuel cell stack 13. The oxidant gas supply hole 35 is included in an inlet-side oxidant gas manifold, to which oxidant gas is supplied, in the fuel cell stack 13. The oxidant gas discharge hole 34 is included in an outlet-side oxidant gas manifold, from which oxidant gas is discharged, in the fuel cell stack 13. The manifolds extend in the stacking direction Z of the single cells 12 when forming the fuel cell stack 13.

An oxidant gas passage (not shown) is formed between the frame 29 and the power generating unit 30 on one side and the first separator 28a on the other side. The oxidant gas passage causes oxidant gas supplied from the oxidant gas supply hole 35 to flow through the power generating unit 30 in the longitudinal direction X and flow into the oxidant gas discharge hole 34. The oxidant gas passage is defined by grooves formed on the surface of the first separator 28a facing the power generating unit 30.

A fuel gas passage is formed between the frame 29 and the power generating unit 30 on one side and the second separator 28b on the other side. The fuel gas passage causes fuel gas supplied from the fuel gas supply hole 32 to flow through the power generating unit 30 in the longitudinal direction X and flow into the fuel gas discharge hole 37. The fuel gas passage is defined by grooves 38 formed on the surface of the second separator 28b facing the power generating unit 30.

When multiple single cells 12 are stacked to form the fuel cell stack 13, a cooling medium passage (not shown) is formed between the first separator 28a of one of two single cells 12 adjacent to each other in the stacking direction Z and the second separator 28b of the other. The cooling medium passage causes the cooling medium supplied from the cooling medium supply hole 36 to flow into the cooling medium discharge hole 33.

### Power Generation by Fuel Cell Stack 13

As shown in FIGS. 1 and 3, in each single cell 12 of the fuel cell stack 13, an oxygen-containing oxidant gas is supplied to a surface of the power generating unit 30 on one side (cathode side) in the stacking direction Z, and a hydrogen-containing fuel gas is supplied to a surface of the power generating unit 30 on the other side (anode side) in the stacking direction Z. As a result, the single cell 12 generates power based on the electrochemical reaction of the fuel gas and the oxidant gas in the power generating unit 30. The single cell 12 generates heat through power generation, and is cooled by a cooling medium flowing through the cooling medium passage (not shown).

### Operation of Embodiment

The operation for assembling the fuel cell 11 will now be described.

As shown in FIGS. 1 and 2, to assemble the fuel cell 11, first, multiple single cells 12 are stacked to form the fuel cell stack 13. Subsequently, the fuel cell stack 13 is sandwiched by the first end plate 14a and the second end plate 14b from the opposite sides of the fuel cell stack 13 in the stacking direction Z of the single cells 12. In this case, the central portion of the first outer surface 22 of the first end plate 14a is provided with one gear 24, which is configured to rotate in both forward and reverse directions about the second axis J2.

Subsequently, the four bolts 16, respectively inserted into the four insertion holes 21 of the second end plate 14b, are respectively inserted into the four insertion holes 21 of the first end plate 14a. As a result, the tips of the shafts 18 of the four bolts 16 protrude outward in the stacking direction Z from the first outer surface 22 of the first end plate 14a. The heads 19 of the four bolts 16 are in contact with the second outer surface 23 of the second end plate 14b.

Then, the heads 19 of the four bolts 16 are fixed to the second outer surface 23 of the second end plate 14b through, for example, welding. As a result, the four bolts 16 do not rotate about the insertion holes 21. Subsequently, the four nuts 17 are respectively fastened to the tips of the shafts 18 of the four bolts 16, which protrude outward in the stacking direction Z from the first outer surface 22 of the first end plate 14a. This causes each of the gear portions 20 of the four nuts 17 to directly mesh with one gear 24.

Thereafter, when a general-purpose tool (e.g., a socket wrench) is engaged with the projection 25 of the gear 24 to rotate the gear 24 in the counterclockwise direction in FIG. 2, the rotational force of the gear 24 is simultaneously transmitted to the four nuts 17. That is, the rotational force of the gear 24 is simultaneously transmitted as a rotational force acting in the clockwise direction in FIG. 2, in which the four nuts 17 are tightened.

As a result, the four nuts 17 are simultaneously tightened with the same predetermined rotational force. This causes the fuel cell stack 13 to be uniformly compressed in the stacking direction Z by the first end plate 14a and the second end plate 14b. Thus, the assembly of the fuel cell 11 is completed. In the fuel cell 11 assembled in this manner, a uniform surface pressure is applied to each single cell 12 of the fuel cell stack 13. Consequently, the quality of the fuel cell 11 becomes more consistent.

In the fuel cell 11, if the surface pressure applied to each single cell 12 of the fuel cell stack 13 is not uniform, the power generation performance of the fuel cell 11 would decrease, resulting in variations in the quality of the fuel cell 11.

### ADVANTAGES OF EMBODIMENT

The embodiment described above in detail has the following advantages. (1) The fuel cell 11 includes the fuel cell stack 13, which includes the stacked plate-shaped single cells 12, and the two end plates 14. Each single cell 12 includes the power generating unit 30 and the two separators 28, which sandwich the power generating unit 30. The two end plates 14 sandwich the fuel cell stack 13 from the opposite sides of the fuel cell stack 13 in the stacking direction Z. The fuel cell 11 further includes multiple fasteners 15 and one gear 24. Each of the fasteners 15 rotates about the respective first axis J1 extending in the stacking direction Z, and has the respective annular gear portion 20. The fasteners 15 fasten the two end plates 14 to each other. The gear 24 is configured to rotate about the second axis J2 extending in the stacking direction Z and is provided on the first outer surface 22 of the first end plate 14a, which is one of the two end plates 14. The gear 24 is meshed with the gear portions 20 of the fasteners 15, and is configured such that a rotational force generated when the gear 24 is rotated is simultaneously transmitted to the fasteners 15 as a rotational force acting in the direction of tightening the fasteners 15.

The above-described configuration allows a rotational force to be transmitted more reliably from one gear 24 to the fasteners 15 (nuts 17) by rotating the gear 24 through meshing between the gear 24 and each gear portion 20. Accordingly, the rotation of one gear 24 allows simultaneous tightening of multiple fasteners 15, thereby allowing the fuel cell stack 13 to be uniformly compressed in the stacking direction Z by the two end plates 14. Thus, since the surface pressure is uniformly applied to each single cell 12 of the fuel cell stack 13, the quality of the fuel cell 11 becomes more consistent.

(2) In the fuel cell 11, the gear 24 transmits a rotational force to the gear portions 20 of the fasteners 15 while being in direct contact with the gear portions 20.

In this configuration, the rotation of the gear 24 allows the rotational force of the gear 24 to be directly transmitted to the fasteners 15 (nuts 17). Thus, the rotational force of the gear 24 is efficiently transmitted to the fasteners 15.

(3) In the fuel cell 11, the center of the gear 24 has, for example, the hexagonal projection 25, which allows engagement with a general-purpose tool when the gear 24 is rotated.

This configuration allows the gear 24 to be rotated by using only a general-purpose tool without requiring a dedicated tool.

### Modifications

The above-described embodiment may be modified as follows. The above-described embodiment and the following modifications can be combined as long as the combined modifications remain technically consistent with each other.

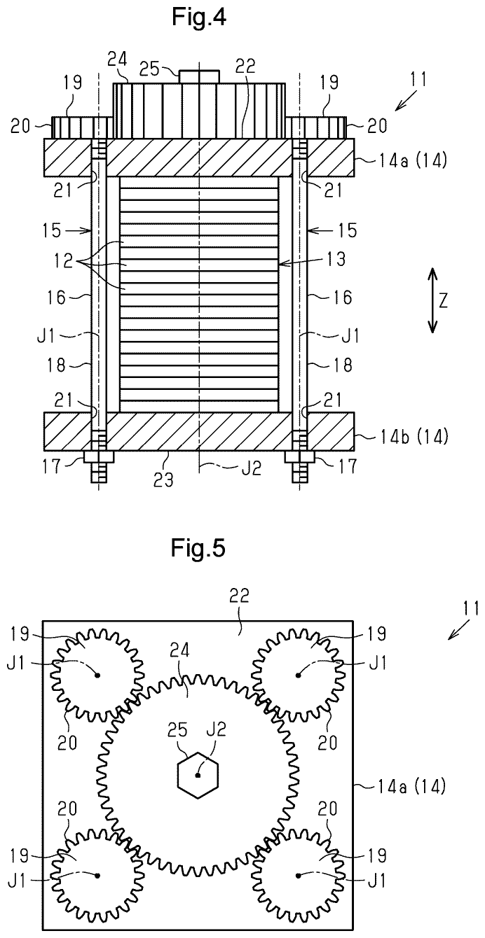

As shown in FIGS. 4 and 5, in the fuel cell 11, the position of each head 19 of the bolt 16 and the position of the corresponding nut 17 may be interchanged. That is, the annular gear portion 20 is integrally formed on an outer edge of the head 19 of the bolt 16. The gear portion 20 of the head 19 of the bolt 16 is meshed with the gear 24. The head 19 of the bolt 16 is in contact with the first outer surface 22 of the first end plate 14a. The tip of the shaft 18 of the bolt 16 protrudes outward in the stacking direction Z from the second outer surface 23 of the second end plate 14b. The nut 17 is fixed to the second outer surface 23 of the second end plate 14b through, for example, welding while being fastened to the tip of the shaft 18 of the bolt 16. This prevents the nut 17 from rotating. Such a configuration provides the same operation and advantages as those of the above-described embodiment.

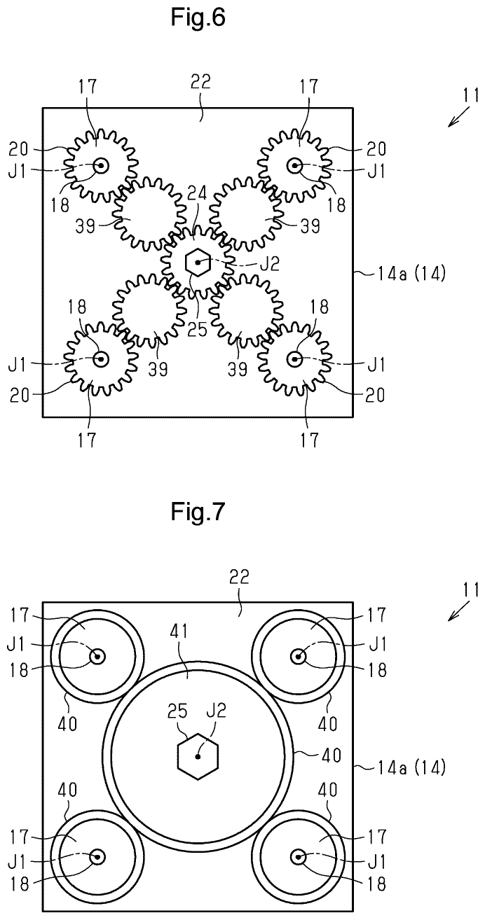

As shown in FIG. 6, the fuel cell 11 may be configured such that the gear portion 20 of each of the four nuts 17 meshes with one gear 24 via one transmission gear 39. In this case, the outer diameters of the gear portion 20 of the nut 17, the transmission gear 39, and the gear 24 may be changed.

The fuel cell 11 of FIG. 6 may be configured such that the gear portion 20 of each of the four nuts 17 meshes with one gear 24 via multiple transmission gears 39.

As shown in FIG. 7, in the fuel cell 11, instead of the gear 24, a disc-shaped rotation member 41 provided with an annular friction member 40 having a relatively high frictional resistance (e.g., rubber) at the outer edge may be used as an example of the rotor, and the gear portion 20 at the outer edge of the nut 17 may be changed to the annular friction member 40. In this case, the friction member 40 of each nut 17 and the friction member 40 of the rotation member 41 are in contact with each other. This allows the rotational force of the rotation member 41 to be transmitted to each nut 17 by the frictional force between the friction member 40 of each nut 17 and the friction member 40 of the rotation member 41. Thus, the same operation and advantages as those of the above-described embodiment are provided.

Instead of the projection 25, a handle used to manually rotate the gear 24 may be provided at the center of the gear 24. This facilitates manual rotation of the gear 24 without a tool.

Instead of the projection 25, a hexagonal recess may be provided at the center of the gear 24. This allows the gear 24 to be rotated using a hexagonal wrench.

In the fuel cell 11, the two end plates 14 may be fastened to each other using two fasteners 15, three fasteners 15, or five or more fasteners 15.

The shape of the end plate 14 does not have to be square, and may be polygonal (e.g., triangular or hexagonal), or may be circular or elliptical.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell, comprising:
a fuel cell stack including stacked plate-shaped single cells, each including a power generating unit and two separators that sandwich the power generating unit;
two end plates that sandwich the fuel cell stack from opposite sides of the fuel cell stack in a stacking direction of the single cells;
fasteners each rotating about a respective first axis and fastening the two end plates to each other, wherein the respective first axis extends in the stacking direction; and
one rotor configured to rotate about a second axis extending in the stacking direction and provided on an outer surface of one of the two end plates in the stacking direction, the one rotor being configured such that a rotational force generated when the one rotor is rotated is simultaneously transmitted to the fasteners as a rotational force acting in a direction of tightening the fasteners.

2. The fuel cell according to claim 1, wherein
the rotor transmits the rotational force to the fasteners while being in direct contact with the fasteners.

3. The fuel cell according to claim 1, wherein
the rotor includes one gear, and
the fasteners each have an annular gear portion that meshes with the one gear.
